(19) United States
(12) Patent Application Publication
(10) Pub. No.: US 2014/0369320 A1
(43) Pub. Date: Dec. 18, 2014

(54) SIGNATURE SEQUENCE SELECTION, SYSTEM VALUE BIT LOADING AND ENERGY ALLOCATION METHOD AND APPARATUS FOR MULTICODE SINGLE-INPUT SINGLE-OUTPUT AND MULTIPLE-INPUT MULTIPLE-OUTPUT PARALLEL CHANNELS

(71) Applicant: Mustafa Kubilay Gurcan, Horsham (GB)

(72) Inventor: Mustafa Kubilay Gurcan, Horsham (GB)

(21) Appl. No.: 14/343,827

(22) PCT Filed: Sep. 7, 2012
(86) PCT No.: PCT/GB2012/000701

§ 371 Date: Sep. 2, 2014

(30) Foreign Application Priority Data
Sep. 8, 2011 (GB) 1115566.0

(51) Int. Cl. H04W 72/04; H04J 13/16

(52) U.S. Cl. CPC H04W 72/0466; H04J 13/16
USPC 370/335

(57) ABSTRACT

A method of transmitting data over a radio data transmission system having a plurality of K parallel single-input single-output or multiple-input multiple-output channels, the method comprising transmitting data at a rate bₚ₊₁ bits per symbol over a first group of (K−m) channels, and at a rate 6, bits per symbol over a second group of m channels, by spreading the data using a number of signature sequences.

### FIELD OF THE INVENTION

The present invention relates to base-station apparatus and a method of providing communication over single-input single-output (SISO) and multiple-input multiple-output (MIMO) multicode and multichannel systems. It is applicable, by no means limited, to signature sequence allocation, bit loading and energy allocation for Code Division Multiple Access (CDMA) SISO and MIMO systems for High Speed Downlink Packet Access (HSDPA) communication systems.

### BACKGROUND TO THE INVENTION

There have been several methods proposed for operational mobile radio systems and apparatus which use CDMA multicode transmission schemes aiming to achieve capacity improvements for the links which make up the system. Recent wireless technologies such as MIMO HSDPA systems [1], which use multi-code spreading sequence transmissions, have been designed to substantially improve the practically achievable sum capacity closer to the theoretical upper bound [2]. For a specifically identified channel impulse response, the sum capacity upper bound of a multi-code transmission system is reached using the well-known water-filling method to adjust the transmission energy and the data rate per spreading sequence.

Alternatively, this maximum sum capacity is also achievable when optimum signature sequences are employed as spreading sequences with equal energy allocation to transmit unequal data rates per channel. However, providing unequal discrete bit rates to achieve the maximum sum capacity with equal energy loading may not be a practical implementation. A near maximum sum capacity can also be achieved when the total energy is unequally allocated such that an equal bit rate is loaded to each channel using the two-group approach described in [22] for HSDPA SISO systems. WO 2010/106330 [22] provides a bit loading and energy allocation method and apparatus for HSDPA downlink transmission. Maximizing the sum capacity with unequal energy loading may require constrained optimization, which normally needs an iterative process to determine the bit rate and energy. The present work improves upon this earlier work by providing a signature sequence selection, bit loading and energy allocation method and apparatus for SISO as well as MIMO systems when estimating the transmission bit rate without using iterative energy allocation for HSDPA down link transmission over mobile radio systems.

There have been many patent documents [3, 4, 5, 6, 7, 8, 9, 10, 11, 12, 13, 14, 15, 16, 17, 18, 19, 20, 21, 22] describing methods and apparatus related to HSDPA and HSDPA MEMO links, comprising a mobile radio network, that aim to improve the transmission capacity over the links. A patent review has been carried out to identify whether any approach has been considered as part of any existing patent document to allocate the transmission bit rate without using iterative energy allocation method whilst using unequal energy allocation when operating over HSDPA multicode SISO and MIMO systems.

US 2011/0019629 [3] discloses a method for selecting a transmission technology (MIMO or non MIMO) for a HSDPA connection established between a RNC (Radio Network Controller) and a UE (User Equipment) depending on the mobility of said UE, measured at the RNC as variations of the position of the UE.

US 2010/0296446 [4] discloses a communication device configured for dynamic switching between Multiple-Input and Multiple-Output (MIMO) and Dual-Cell High Speed Downlink Packet Access (DC HSDPA).

US 2010/0238886 [5] discloses a method, an apparatus, and a computer program product for wireless communication in which a single channelization code may be utilized on an uplink channel for providing a HARQ ACK/NACK response corresponding to DC-HSDPA+MIMO. Here, the set of channelization codes includes four codeword groups, each codeword group corresponding to a scenario wherein a node B schedules a single transport block or dual transport blocks on each of the two downlink carriers.

US 2009/0161690 [6] provides a method and system for channel estimation in a single channel MIMO system comprising two-transmit and multiple-receive antennas for WCDMA/HSDPA in a wireless system.

US 2009/0135893 [7] provides a method which may comprise generating models for a received plurality of spatially multiplexed communication signals for multiple channels from a plurality of transmit antennas.

US 2006/0072514 [8] discloses methods and systems for processing signals in a receiver which may comprise receiving spatially multiplexed signals via M receive antennas.

US 2006/0072607 [9] provides a method and system for channel estimation in a single channel MIMO system comprising two-transmit and multiple-receive antennas for WCDMA/HSDPA in a wireless system.

US 2006/0072629 [10] provides aspects for implementing a single weight single channel MIMO system with no insertion loss which may comprise generating at least one control signal that is utilized to control at least one of a plurality of received signals in a WCDMA and/or HSDPA system.

US 2010/0254315 [11] discloses a method for indicating a modulation mode in HSDPA when a terminal reports a Node B receiving capability information which determines a transmission block size, a modulation mode and code channel resource.

US 2010/0234058 [12] discloses a method and arrangement in a radio communication network for predicting channel quality on a downlink channel. A radio base station (RBS) transmits data on the downlink channel to one or more user equipment (UEs), each of which transmits a channel quality indicator to the RBS on an uplink channel. The RBS derives a needed downlink transmission power from the received channel quality indicator, and predicts a channel quality for a next downlink transmission based on the received channel quality indicator.

US 2010/0208635 [13] discloses a device for communicating with a mobile device. The devices include a transmitter. The transmitter transmits a first modulation scheme, a first transport block size, and a first redundancy version to a mobile device. The first transport block size is represented by a first number of bits and the first redundancy version is represented by a second number of bits. The transmitter transmits a packet based on the first modulation scheme to a mobile device for an HSDPA system.

US 2010/0322224 [14] provides a server and a terminal enabling channel capacity estimation in a High-Speed Downlink Packet Access (HSDPA) network and a method of controlling the server and the terminal. More particularly, when transmitting data between both terminals in an HSDPA network, a server end may transmit a packet pair of the same size and a client end may measure a time difference between the packet pair and thereby proceed filtering. Through this, it is possible to estimate the channel capacity.

US 2010/0311433 [15] discloses a telecommunication system comprising a radio network controller (RNC), and a Node-B (NB) for enabling wireless communication with a user terminal (UE). The RNC establishes an enhanced dedicated transport channel (E-DCH) which enables uplink data traffic with a determined maximum data rate from the user terminal (UE) to the NB. The RNC further establishes a high speed DL shared channel (HS-DSCH) which enables downlink data traffic with a determined maximum data rate from the NB to the user terminal.

US 2010/0298018 [16] discloses a method of indicating to a secondary station a set of at least one available transmission resource among a predetermined plurality of transmission resources, each set being described by a plurality of parameters for HSDPA systems.

US 2008/0299985 [17] discloses a method of allocating downlink traffic channel resources for multi-carrier HSDPA, and the method includes: first of all, selecting a carrier with the optimum channel condition; determining whether the carrier meets the resource allocation demand of a downlink traffic channel, if yes, allocating resources that meet the downlink traffic channel on the carrier; otherwise, allocating the available resources of the carrier to the downlink traffic channel, and selecting a carrier with the optimum channel condition from the remaining carriers for resource allocation according to the remaining resource allocation demand of the downlink traffic channel.

US 2007/0091853 [18] discloses a transmission unit comprising a first unit (CM_SCHDR) receiving scheduled first data (DATA2, DATA3) for transmission on at least a first channel, a power control unit (PWR_CTRL) for the first channel responsive to a respective closed loop power regulation signal (TCP_CMD), under which at least the transmit power rate of change is limited to a predetermined value per time unit, a packet data scheduler (HS_SCHDR) scheduling second data packets (DATA1), such as HSDPA data.

US 2007/0072612 [19] discloses a wireless (radio) communication system having a high-speed packet communication function, which is based on an HSDPA (High Speed Downlink Packet Access) system, the wireless communication system including a base station control device, the base station control device including a unit receiving from a handover source base station.

US 2006/0252446 [20] discloses a method and apparatus for setting a power limit for high speed downlink packet access (HSDPA) services. In a wireless communication system comprising a plurality of cells, each cell supports transmissions via at least a dedicated channel (DCH) and a HSDPA channel and is subject to a maximum downlink transmission power limit.

US 2006/0246939 [21] relates to wireless communication networks, and to the way in which communication devices choose their transmission power when communicating with each other. More specifically, the invention relates to a method of controlling the transmission power of a first communication device in a wireless communications network based on the UMTS standard, the first communication device having established a HSDPA connection to a second communication device, whereby the absolute value of the difference between the HSDPA transmission power in a first transmission time interval (tti1) and the HSDPA transmission power in a subsequent second transmission time interval (tti2) is chosen to be smaller than a predetermined value (v).

### The Main Problem

The main problem tackled in the present work is to improve the two-group [25, 26, 27, 28, 29, 30, 31, 32, 33, 34, 35, 36] resource allocation scheme described in WO 2010/106330 [22], which has been shown to produce a near optimal system throughput. This method loads the total energy over two groups of channels to realize two adjacent discrete bit rates bₚ and bₚ₊₁ bits per symbol when implementing the following constrained optimization solution for a given total constrained energy E_{T}:

$$max {R}_{T} = ( K - m ) {b}_{p} + {mb}_{p + 1} \\ subject to \text{:} {E}_{sum} = {\sum }_{k = 1}^{K} {E}_{k} \leq {E}_{T} , \qquad ( 1 )$$

The two-group resource allocation scheme was originally formulated to use the total constrained energy E_{T} by allocating two adjacent bit rates bₚ and bₚ₊₁ over two groups of channels to be transmitted in two groups of channels, where m is the number channels transmitting the higher data rate bₚ₊₁.

For a constrained optimization, a discrete time domain multi-code HSDPA system model can be considered with a maximum of K parallel code channels, an ((N+L−1)×N)-dimensional channel convolution matrix matrix H, an orthonormal signature sequence matrix S=└\vec{s}₁ . . . \vec{s}_{K}┘ with a spreading factor of N, a set of realizable discrete bit rates {bₚ}ₚ₌₁^{P} and a total constrained energy of E_{T} per symbol. In order to determine the desired total bit rate R_{T} the energy Eₖ for k=1, . . . , K needs to be iteratively calculated to find the highest possible bit rate bₚ to be allocated to a channel k using the following iterative energy calculation [23]

$${E}_{k} = \frac{{γ}_{k}^{*}}{( 1 + {γ}_{k}^{*} ) {\overline{q}}_{k}^{H} {C}^{- 1} {\overline{q}}_{k}} , \qquad ( 2 )$$

where γₖ*=Γ(2^{y}^{ₖ}−1) is the target SNIR when transmitting data at the rate yₖε{bₚ: p=1, . . . , P−1} and Q=HS=[\vec{q}₁, . . . \vec{q}_{K}] is the receiver signature sequence matrix and also C⁻¹ is the inverse covariance matrix. The term F is the gap value [24]. The energy calculation method, as given in equation (2) is an iterative process as the energy equation given in the above optimization problem depends on the target SNR, γₖ*, for a bit rate yₖ=bₚ and the inverse covariance matrix C⁻¹, which is a function of the energy. If the maximum number of iterations required to calculate the energy is Iₘₐₓ, iterative energy calculation becomes computationally expensive especially as the number K of the channels and the number P of the discrete bit rates increase. The maximum possible bit rate combinations is as high as P^{K}; this may require a maximum number of IₘₐₓP^{K} matrix inversions to identify the data rates to be transmitted and energies to be allocated for each channel k for k=1, . . . , K.

The maximum number of energy calculation iterations to determine the rate and the energy using the two-group resource allocation scheme is reduced to (P+K−1)Iₘₐₓ as there are P discrete bit rates and the maximum number m of channels for the second group is K−1. Furthermore, each of these iterations requires a matrix inversion C⁻¹, which is still computationally expensive. Therefore, the present work provides a solution to reduce the maximum number of iterations from (P+K−1)Iₘₐₓ to Iₘₐₓ to obtain the optimized total transmission rate using a closed form rate calculation method referred to as the system value approach which is integrated with the two group approach.

There are Three Aspects of the Present Work:

The first aspect of the present work deals with finding the optimum signature sequences to be used S=└\vec{s}₁ . . . \vec{s}_{K}┘ for a given channel impulse response matrix to maximize the total transmission rate.

The second aspect of the present work deals with calculating the transmission bit rates bₚ and bₚ₊₁ over two groups of channels, and also m (the number channels transmitting the higher data rate bₚ₊₁), without using iterative energy calculations by using the system value approach. This reduces the number of iterations and hence the number of matrix inversions from (P+K−1)Iₘₐₓ to Iₘₐₓ when allocating energies to transmit the required rates bₚ and bₚ₊₁ over two groups of channels.

The third aspect of the present work deals with eliminating the need to invert a covariance matrix per energy iteration when calculating the energy for each channel iteratively. The inverse of the covariance matrix for each spreading sequence is calculated for a given energy allocation. Energy for a given spreading sequence channel is iteratively estimated using the inverse of the previous channel covariance matrix and the previous energy allocated for the current channel. The inverse of the covariance matrix for the current channel is then calculated using the inverse of the previous channel covariance matrix and also the energy allocation for the current channel.

### SUMMARY OF THE INVENTION

### The First Aspect of the Present Work

According to the first aspect of the present work there is provided a method of transmitting data over a radio data transmission system, as defined in Claim 1 of the appended claims. It should be noted that, although Claim 1 and its dependent claims specify a method of transmitting data, the processing steps involved may be implemented at the transmitter or the receiver, as those skilled in the art will appreciate.

The maximization of the total rate R_{T} for a given total energy E_{T}, depends on the signature sequences S=└\vec{s}₁ . . . \vec{s}_{K}┘ and also the number of channels to be used. The objective here is to find the signature sequence matrix S=└\vec{s}₁ . . . \vec{s}_{K}┘ which will maximize the total rate for a given channel impulse response matrix H. The first aspect involves the following inventive steps in the calculation of optimum signature sequences for single-in-single-out (SISO) and multiple-in-multiple-out (MIMO) transmission systems. The steps are
identification of the optimum sequences;
the calculation of optimum number of signature sequences and
the use of optimum signature sequences in the transmission system model description.
1. For the optimum signature sequence identification, channel matrix H is considered. For the SISO systems it is assumed that the channel convolution matrix is H. For the MIMO systems with two transmit and two receive antennas the channel convolution matrix is

$$H = [ \begin{matrix}{H}_{1 , 1} & & {H}_{1 , 2} \\ & & \\ {H}_{2 , 1} & & {H}_{2 , 2}\end{matrix} ]$$

where H_{i,j} for i=1,2 and j=1,2 is the channel convolution matrix between transmitter antenna j and receiver antenna i.

The receiver matched filter matrix is given by Q=HS=└\vec{q}₁ . . . \vec{q}_{K}┘. The orthogonal transmitter signature sequence is given in terms of the Gram matrix H^{H}H=V_{H}D_{H}V_{H}^{H} where D_{H} is the diagonal matrix of Eigen values and V_{H} is the matrix of Eigen vectors. The optimum spreading sequence is obtained by S=└\vec{s}₁ . . . \vec{s}_{K}┘. The channel gains of the transmission system is taken to be |hₖ|²=[Q^{H}Q]_{k,k} for k=1, . . . , K and the optimum signature sequences and channel gains are used to establish the number of channels to be used.
2. For estimating the optimum number of channels a method similar to the water filling algorithm, which is well known to those skilled in the art of HSDPA systems, is used where the signature sequence matrix S is ordered such that the channel gains |hₖ|² appear in a descending order. The matched filter channel-SNIR gₖ for channel k is

$${g}_{k} = \frac{{\vert {h}_{k} \vert}^{2}}{2 {σ}^{2}}$$

for k=1, . . . , K where 2σ² is the noise per channel for the system with

$${σ}^{2} = \frac{{N}_{0}}{2}$$

for two sided noise power spectral density of

$$\frac{{N}_{0}}{2} .$$

The objective here is to determine the optimum number, K*, of signature sequences to be used. Initially K* is set to be K*=K. The water filling energies

$${E}_{k} = \frac{1}{{K}^{*}} [ {E}_{T} + \frac{1}{Γ} {\sum }_{k = 1}^{{K}^{*}} \frac{1}{{g}_{k}} ] - \frac{1}{Γ {g}_{k}}$$

are calculated for k=1, . . . , K*. If the energy E_{K*}, for the last channel K*, is negative then K* is set to be (K*−1) and the energy calculation process is repeated until all energies are positive. The resultant K* signature sequences S=└\vec{s}₁ . . . \vec{s}_{K*}┘ are re-ordered such that the corresponding channel gains |hₖ|² appear in an ascending order to produce a description for the system model.
3. The optimum signature sequences are used to determine the covariance matrix C and also the normalized receiver despreading filters \vec{w}_{k,n} for the transmission system using the steps as follows. The resultant signature sequences S=└\vec{s}₁ . . . \vec{s}_{K*}┘ are initially used to produce the extended matched filter receiver signature sequence matrix Qₑ=[HS, H_{Prev}S, H_{Next}S] where for the SISO systems H_{Prev}=(J^{T})^{N}H and H_{Next}=J^{N}H and for the MIMO systems

$${H}_{Prev} = [ \begin{matrix}{( {J}^{T} )}^{N} {H}_{1 , 1} & & {( {J}^{T} )}^{N} {H}_{1 , 2} \\ & & \\ {( {J}^{T} )}^{N} {H}_{2 , 1} & & {( {J}^{T} )}^{N} {H}_{2 , 2}\end{matrix} ] and$$

$${H}_{Next} = [ \begin{matrix}{J}^{N} {H}_{1 , 1} & & {J}^{N} {H}_{1 , 2} \\ & & \\ {J}^{N} {H}_{2 , 1} & & {J}^{N} {H}_{2 , 2}\end{matrix} ]$$

Where J is an ((N+L−1)×(N+L−1))-dimensional matrix formed by

$$J = [ \begin{matrix}{0}_{1 \times ( N + L - 2 )} & 0 \\ {I}_{( N + L - 2 )} & {0}_{( N + L - 2 ) \times 1}\end{matrix} ]$$

here the term N is the spreading sequence length, and L is the channel impulse response length. The terms H_{Prev} and H_{Next} correspond to the channel impulse responses for the previous and the next symbol periods respectively. When considering an Mary-QAM transmission system with unity average transmission energy, it is assumed that the transmitted signal amplitudes are adjusted in accordance with the extended amplitude square matrix Aₑ²=Diag(└\vec{E} \vec{E} \vec{E}┘) where the energy vector is given by \vec{E}=[E₁, E₂, . . . E_{K}]. For the allocated energies the receiver covariance matrix is obtained using C=QₑAₑ²Q_{g}^{H}+2σ²I_{N}_{ᵣ}_{(N+L-1)} where Nᵣ is the number of receiver antennas. When using the MMSE (minimum-mean-square-error) optimization the normalized receiver filter coefficients is given by

$${\vec{w}}_{k , n} = \frac{{C}^{- 1} {\vec{q}}_{k}}{{\vec{q}}_{k}^{H} {C}^{- 1} {\vec{q}}_{k}} .$$

### The Second Aspect of the Present Work

To address the problem of estimating the number of bits bₚ and bₚ₊₁, and also the number m which is the number of channels transmitting the higher data rate bₚ₊₁ without estimating the energies iteratively, the method may include the further steps defined in Claim 2 of the appended claims, which may be considered to form a second aspect of the present work.

This second aspect may be organized to have the following steps:
1. Design a set of optimum signature sequences for multi-code systems to remove the MAI or use a set of orthogonal signature sequences when considering multipath channel matrix H. Then remove any weak channels, if any, as outlined in step 2 of the first aspect of the present work to maximize the sum capacity, hence the total bit rate.
2. Produce a sum capacity upper-bound with the previously identified optimum signature sequences and equal energy loading. This upper-bound is expressed in terms of a parameter introduced as a system value, which reaches its maximum when the total energy is equally distributed over all channels.
3. Incorporate a closed-form bit rate calculation method, which requires no energy calculation iterations, into a two-group resource allocation scheme, which considers only two adjacent bit rates to be allocated over the K parallel code channels.

When designing an MMSE equalizer at the receiver we use a parameter λₖ which we refer to as the system value and is given by

λₖ=Eₖ\vec{q}ₖ^{H}C⁻¹\vec{q}ₖ (3)

The maximum total system value λ_{T,max} over K* employed code channels is expressed as

$${λ}_{T , ma x} = \frac{{E}_{T}}{{K}^{*}} {\sum }_{k = 1}^{{K}^{*}} {\vec{q}}_{k}^{H} {C}^{- 1} {\vec{q}}_{k} \qquad ( 4 )$$

We consider target system values

$${λ}^{*} ( {b}_{p} ) = \frac{Γ ( {2}^{{b}_{p}} - 1 )}{1 + Γ ( {2}^{{b}_{p }} - 1 )} and {λ}^{*} ( {b}_{p + 1} ) = \frac{Γ ( {2}^{{b}_{p + 1}} - 1 )}{1 + Γ ( {2}^{{b}_{p + 1}} - 1 )}$$

if we wish to transmit data rates bₚ and bₚ₊₁. By using the total system value λ_{T,max}, the total bit rate Rᵣ=(K−m)bₚ+mbₚ₊₁ for the two-group resource allocation scheme is determined by using the system value approach and the following inventive steps to reduce the number of iterations from (P+K−1)Iₘₐₓ to Iₘₐₓ.
1. Calculate the receiver signature sequence matrix Q=HS=[\vec{q}₁ . . . \vec{q}_{K}] and sort the diagonal elements [Q^{H}_{Q}]_{k,k} in a descending order for k=1, . . . K. Perform a simplified water-filling theorem to find the optimal number K*. Then reorder the signature sequences such that the channel gains, |hₖ|², appear in an ascending order. Calculate the extended receiver signature sequence of Qₑ=[HS, H_{Prev}S, H_{Next}S] (for ISI case).
2. Calculate the covariance matrix

$$C = \frac{{E}_{T}}{{K}^{*}} {Q}_{e} {Q}_{e}^{H} + 2 {σ}^{2} {I}_{Nr ( N + L - 1 )}$$

and also the system value

$${λ}_{k} = \frac{{E}_{T}}{{K}^{*}} {\vec{q}}_{k}^{H} {C}^{- 1} {\vec{q}}_{k}$$

for k−1, . . . , K*, the total system value λ_{T,max}=Σₖ₌₁^{K*}λₖ and the mean system value

$${λ}_{mean} = \frac{{λ}_{T , ma x}}{{K}^{*}} .$$

3. Find bₚ by satisfying the following inequality)

λ*(bₚ)≦λₘₑₐₙ<λ*(bₚ₊₁) (5)
4. Find the highest integer in value by satisfying the following inequality

(K*−m)λ*(bₚ)+mλ*(bₚ₊₁)<λ_{T,max} (6)

It is clear from the step-by-step procedures presented above, the total bit rate R_{T}=(K*−m)bₚ+mbₚ₊₁ for the two-group resource allocation scheme is determined without using any energy calculation iterations. Instead of requiring (P+K−1)Iₘₐₓ energy calculation iterations, hence the number of matrix inversions and the number of matrix inversions required by this simplified rate calculation method based on the system value approach is only one. Once the rates for each channel is found, the energies for each channel needs to be calculated. This requires a total of Iₘₐₓ iterative energy calculations which requires the use of iterative energy equation as follows.
5. Allocate

$${E}_{k} = \frac{{E}_{T}}{{K}^{*}}$$

for k=1, . . . , K* and set i=1 and formulate the extended amplitude matrix A_{e,i}² and formulate the covariance matrix Cᵢ=QₑA_{e,i}²Qₑ^{H}+2σ²I_{Nr(N+L-1)}.
6. Set the target system value for the first (K*−m) channels to be

$${λ}^{*} ( {b}_{p} ) = \frac{Γ ( {2}^{{b}_{p}} - 1 )}{1 + Γ ( {2}^{{b}_{p}} - 1 )}$$

and the remaining m channels to be

$${λ}^{*} ( {b}_{p + 1} ) = \frac{Γ ( {2}^{{b}_{p + 1}} - 1 )}{1 + Γ ( {2}^{{b}_{p + 1}} - 1 )} .$$

7. Solve the energy equations iteratively using

$${E}_{k , i + 1} ( {b}_{p} ) = \frac{{λ}^{*} ( {b}_{p} )}{{[ {{Q}^{H} ( {Q}_{e} {A}_{e , i}^{2} {Q}_{e}^{H} + 2 {σ}^{2} {I}_{Nr ( N + L - 1 )} )}^{- 1} Q ]}_{k , k}} \qquad ( 7 )$$

or k=1, . . . , (K−m) and

$${E}_{k , i + 1} ( {b}_{p + 1} ) = \frac{{λ}^{*} ( {b}_{p + 1} )}{{[ {{Q}^{H} ( {Q}_{e} {A}_{e , i}^{2} {Q}_{e}^{H} + 2 {σ}^{2} {I}_{Nr ( N + L - 1 )} )}^{- 1} Q ]}_{k , k}} \qquad ( 8 )$$

for k=1, . . . , (K−m) and for k=(K−m+1), . . . K respectively. Then iteratively formulate the energy vector \vec{E}ᵢ₊₁=[E_{1,i+1}, E_{2,i+1}, . . . , E_{K,i+1}] and set i=i+1 and formulate the extended amplitude square matrix as A_{e,i}²=Diag(└\vec{E}i \vec{E}i \vec{E}i┘). Repeat the iterations given in step 7 until E_{k,i}=E_{k,(i-1)} or the maximum number of iterations Iₘₐₓ is reached.

Each of these energy calculation iterations given in equations (7) and (8) requires a matrix inversion C⁻¹ and up to Iₘₐₓ matrix inversions may be required which is computationally expensive. Therefore, a third aspect of the present work, as defined in Claim 3 of the appended claims, uses the following steps to reduce the computational complexity for the iterative energy calculation.

### The Third Aspect of the Present Work

It has already been noted that the second aspect of the present work is to reduce the number of iterations from (P+K−1)Iₘₐₓ to Iₘₐₓ using a closed form rate calculation method, which finds the total bit rate without using any energy calculations by means of the system value approach. The number of matrix inversions required by this simplified rate calculation method based on the system value approach is only one. Once the rates for each channel is found, the energies for each channel needs to be calculated. This requires a total of Iₘₐₓ iterative energy calculations using the system value approach. The third aspect of the present work involves two steps.
Iterative energy calculation for a given spreading sequence using the inverse of the covariance matrix of the previous channel and also the energy of the previous iteration for the current channel.
Calculation of the inverse of the covariance matrix for the current channel using the energy allocated to the current channel and also the inverse of the covariance matrix for the previous channel.
   The Details of these Steps are:
1. As part of the second aspect of the present work, a simplified energy calculation method is developed using the lower bit rate bₚ, bₚ₊₁ and the number m of the channels calculated by using a method referred to as the system value approach. When implementing the energy calculation Eₖ for channel k, the main parameter, which changes from one channel to another during the energy calculation process, is the inverse covariance matrix Cₖ₋₁⁻¹. The first matrix inversion used is C₀⁻¹=(2σ²)⁻¹I_{N}_{ᵣ}_{(N+L-1)}, which is computationally inexpensive to be produced. The energy calculation starts from channel k=1 for inverse matrix C₀⁻¹ is available.
2. For the energy Eₖ calculation for k=1, . . . , K, the distance vectors, \vec{d}, \vec{d}₁, \vec{d}₂ are defined as \vec{d}=Cₖ₋₁⁻¹\vec{q}ₖ, \vec{d}₁=Cₖ₋₁⁻¹\vec{q}_{k,1} and \vec{d}₂=Cₖ₋₁⁻¹\vec{q}_{k,2} where \vec{q}_{k,1}=H_{Prev}\vec{s}k and \vec{q}_{k,2}=H_{Next}\vec{s}k. Further the weighting factors, ξ, ξ₁, ξ₂, ξ₃, ξ₄ are calculated using ξ=\vec{d}^{H}\vec{q}ₖ, ξ₁=\vec{d}₁^{H}\vec{q}_{k,1}, ξ₂=\vec{d}₂^{H}\vec{q}_{k,2}, ξ₃=\vec{d}^{H}\vec{q}_{k,1} and ξ₄=\vec{d}^{H}\vec{q}_{k,2}. If it is identified that the data rate to be transmitted over channel channel k is bₚ bits per symbol, for a target SNR of γₖ*=Γ(2^{b}^{ₚ}−1), the energy E_{k,i} is iteratively calculated using the distance vectors and weighting factors

$${E}_{k , i} = \frac{Γ ( {2}^{{y}_{k}} - 1 )}{ξ - {E}_{k , ( i - 1 )} ( \frac{{\vert {ξ}_{3} \vert}^{2}}{1 + {E}_{k , ( i - 1 )} {ξ}_{1}} + \frac{{\vert {ξ}_{4} \vert}^{2}}{1 + {E}_{k , ( i - 1 )} {ξ}_{2}} )} \qquad ( 9 )$$

and also the energy Eₖ₍ᵢ₋₁₎ at channel k itself. Therefore, the maximum number Iₘₐₓ of iterations required to determine the energy Eₖ is relatively low and does not require the covariance matrix to be inverted per energy iteration.
3. With the calculated energy Eₖ, the inverse covariance matrix Cₖ⁻¹ needs to be calculated by further defining the matrix weighting factors ζ, ζ₁ and ζ₂ as

$$ζ = \frac{{E}_{k}}{1 + Γ ( {2}^{{b}_{p}} - 1 )} , {ζ}_{1} = \frac{{E}_{k}}{1 + {E}_{k} {ξ}_{1}} and {ζ}_{2} = \frac{{E}_{k}}{1 + {E}_{k} {ξ}_{2}} .$$

The inverse of the covariance matrix Cₖ⁻¹ is calculated as:

$${C}_{k}^{- 1} = {C}_{k - 1}^{- 1} - ζ \vec{d} {\vec{d}}^{H} - ( {ζ}_{1} + ζ {ζ}_{1}^{2} {\vert {ξ}_{3 } \vert}^{2} ) {\vec{d}}_{1} {\vec{d}}_{1}^{H} - ( {ζ}_{2} + {ζζ}_{2}^{2} {\vert {ξ}_{4} \vert}^{2} ) {\vec{d}}_{2} {\vec{d}}_{2}^{H} + {ζζ}_{1} ( {ξ}_{3} \vec{d} {\vec{d}}_{1}^{H} + {{ξ}_{3}^{*} ( \vec{d} {\vec{d}}_{1}^{H} )}^{H} ) + {ζζ}_{2} ( {ξ}_{4} \vec{d} {\vec{d}}_{2}^{H} + {{ξ}_{4}^{*} ( \vec{d} {\vec{d}}_{2}^{H} )}^{H} ) - {ζζ}_{1} {ζ}_{2} ( {ξ}_{3} {ξ}_{4}^{*} {\vec{d}}_{2} {\vec{d}}_{1}^{H} + {( {ξ}_{3} {ξ}_{4}^{*} )}^{*} {( {\vec{d}}_{2} {\vec{d}}_{1}^{H} )}^{H} ) \qquad ( 10 )$$

This implementation of iterative energy calculation and inverse of the covariance matrix calculation requires that a successive interference cancellation (SIC) is used at the receiver. In short, this SIC-based energy calculation algorithm is designed as follows:
4. Calculate the initial inverse covariance matrix C₀⁻¹=(2σ²)⁻¹I_{N+L-1} and start the channel number as k=1.
5. Determine the distance vectors, \vec{d}, \vec{d}₁, \vec{d}₂ and the weighting factors ξ, ξ₁, ξ₂, ξ₃, ξ₄.
6. Determine the target signal-to-noise ratio (SNR) as γₖ*=Γ(2^{y}^{ₖ}−1) for yₖε{bₚ, bₚ₊₁} and set the energy as E_{k,0}=E_{T}/K.
7. Determine the energy E_{k,i} iteratively from i=1 to Iₘₐₓ.
8. Determine the matrix weighting factors ζ, ζ₁ and ζ₂.
9. Determine the inverse covariance matrix Cₖ⁻¹ using equation (10).
10. If k<K*, update k=k+1 and go to Step 2. Otherwise terminate the calculation.

### BRIEF DESCRIPTION OF THE DRAWINGS

Embodiments of the invention will now be described, by the way of example only, and with reference to the drawings in which:

FIG. 1 illustrates the transmitter of a HSDPA MIMO downlink packet access scheme known from the prior art (Reference 1 and 2);

FIG. 2 illustrates the receiver of a HSDPA MIMO downlink packet access scheme known from the prior art (Reference 1 and 2).

FIG. 3 illustrates the transmitter of a system according to an embodiment of the present invention; and

FIG. 4 illustrates the receiver of a system according to an embodiment of the present invention, being operable with the transmitter of FIG. 3.

In the figures, like elements are indicated by like reference numerals.

### DETAILED DESCRIPTION OF PREFERRED EMBODIMENTS

The present embodiments represent the best ways known to the applicant of putting the invention into practice. However, they are not the only ways in which this can be achieved.

Initially a HSDPA MIMO downlink packet access scheme known from the prior art will be described. After this, an example is given to show how the optimum transmission signature sequences will be calculated and this will be followed by the system value approach description which is used to estimate the transmission bit rates with iterative energy calculation.

The methods described in this work may be automatically initiated or used when the amount of data gathered at the transmitter is greater than the amount of data that can be carried in a block over the parallel channels. This may be done on an ongoing basis or at regular intervals, whenever a user is granted access to the channel.

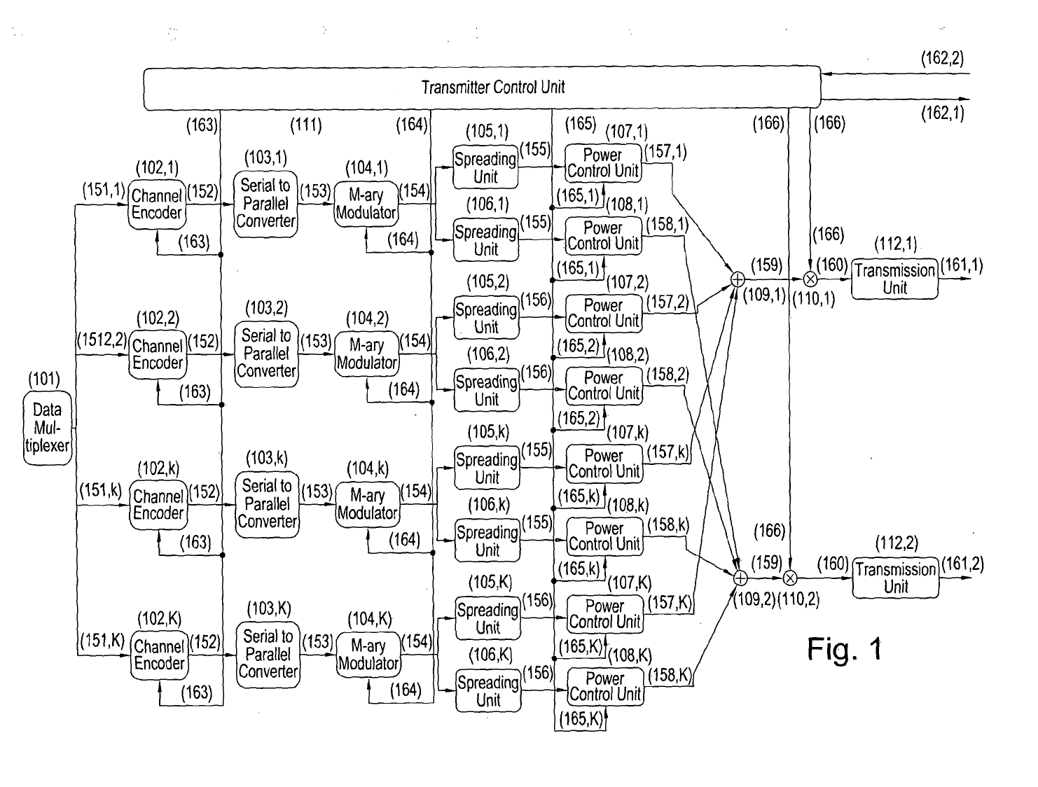

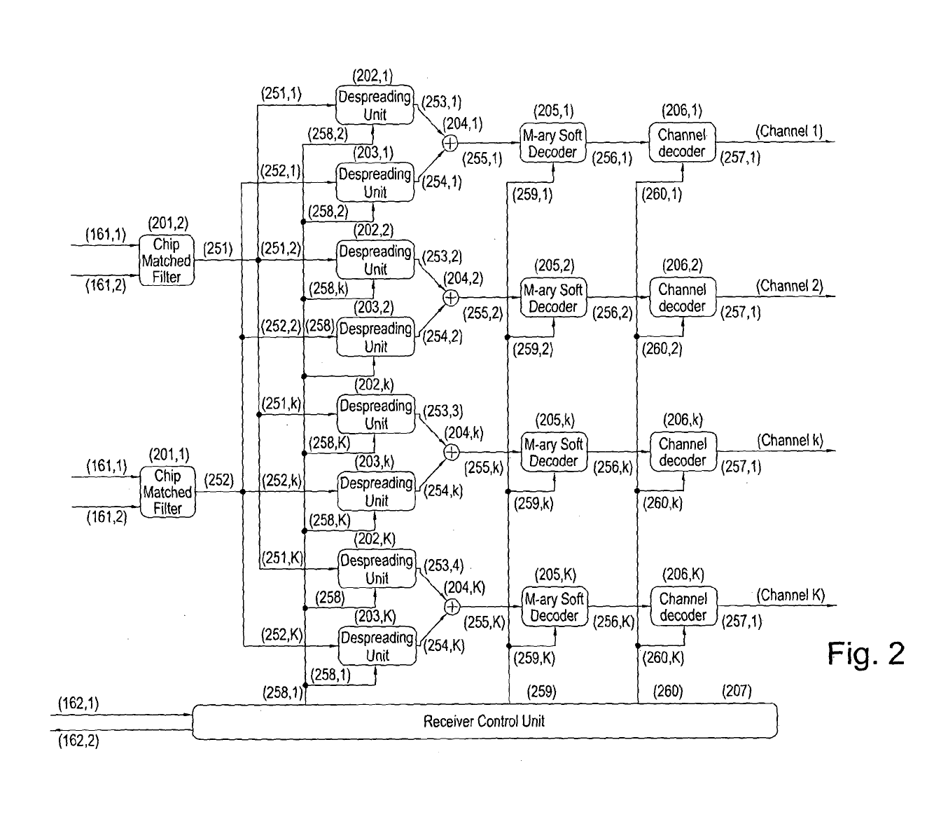

The principal elements of the HSDPA MIMO transmitter and receiver are shown in FIGS. 1 and 2 for the prior art systems. At the transmitter (FIG. 1) of the scheme described in Reference [1, 2], the binary data from the source appears at the data multiplexer 101. Blocks of data are divided into K sub-blocks. The first block is fed to the channel encoder 102 via the link 151,1. The second sub-block is fed at 151,2 to a second channel encoder which may be the same as 102. Likewise, the remaining sub-blocks are fed to the corresponding channel encoders. From the point of operation, each of the sub-channels functions in the same way and hence, from hereon consideration will be devoted to sub-channel 1. Data from the channel encoder 102 is fed to a serial-to-parallel converter 103. In the serial to parallel converter successive blocks of b binary bits are taken at 152 and fed at 153 to an M-ary signal generator 104. The term M-ary, as used herein, is well known in the art, and refers to M-level signal used in modulation, with M being the order of modulation as those skilled in the art will appreciate. The M-ary signal generator 104 produces at its outputs 154 a signal which can take one of 2^{b} different values. These signals may be voltage values. The signals appearing 154,1 and 154,2 are then fed to two symbol spreading units 105 and 106 which operate in a manner that is well known to those skilled in the art of spread spectrum and CDMA systems. The signals at the links 155 and 156 are then power amplified by the transmission power control units 107 and 108. Next K signals appearing at the link 157 are added in the adder 109,1 and also K signals appearing at 158 are added in the adder 109,2. Signals appearing at 159,1 and 159,2 are then fed to the multipliers 110,1 and 110,2 respectively. Finally, the signals appearing at the links 160,1 and 160,2 are fed to the transmission units 112,1 and 112,2 prior to transmission over the communication channel 161,1 and 161,2. It will be appreciated that pass band modulation and demodulation may be involved and block diagram descriptions in FIGS. 1 and 2 represent the equivalent baseband schemes for such systems, which operate in a manner that is well known to those skilled in the art of digital transmission systems. The transmitter control unit 111 at the transmitter uses the links 162,1 and 162,2 as control channels to communicate with the receiver control unit 207 at the receiver. The channel gain |hₖ|² information, the noise level σ² at the receiver and also the multipath channel impulse responses are obtained at the receiver by the receiver control unit 207 using the information received from the transmitter. The receiver control unit 207 feeds back some of this information to the transmitter control unit 111 at the transmitter using the link 162,2. This information is used at the transmitter control unit 111 to control the channel encoder 102, the M-ary signal generator 104 and the power control units 107, 108 and also the multipliers 110,1 and 110,2. The control unit 111 sends the channel encoder rate to the channel encoder 102 via the link 163. The control unit 111 sends the modulation level information b to the M-ary signal generator 104 via the link 164. The control unit 111 sends the transmission energy level information to the power control units 107 and 108 via the link 165. The transmitter control unit 111 sends the multiplier information to the multipliers 110,1 and 110,2 via the links 166.

The basic operation of the HSDPA MIMO transmitter will now be described. The HSDPA MIMO system uses adaptive modulation and coding (AMC), fast packet scheduling at the base station and fast retransmissions from the base station which are known as the hybrid repeat-request (HARQ). There are different data rates bₚ for p=1, . . . , P that can be achieved when combining various modulation and coding rates. The modulation scheme and coding rate are changed on a per user basis depending the quality and cell usage. The modulated symbol at the link 104 is fed to the symbol spreading units 105 and 106 at intervals of T seconds which is known as the symbol period. The spreading units 105 and 106 use the same spreading sequence, per transmission channel k, which is otherwise known as the channelization code and produce the spread signals at the links 155 and 156. The spreading signal sequence has a length N which is known as the processing gain or spreading factor. For the HSDPA system, the processing gain is N=16 and the frequency division duplex system has a chip rate 3.84 Mbps hence the chip period is T_{c}=0.26 μs. The CDMA system has the transmission symbol period equal to T=N×T_{c}. The symbol period for the HSDPA system is T=4.11667 μs. The spread signals at the output of the adders 109 are weighted at the weighting units 110,1 and 110,2 using two different weighting coefficients, which are generated by the transmitter control unit 311, before being transmitted over the transmitters 112,1 and 112,2. Here, a description of the HSDPA MIMO system is provided for two transmitter and two receiver antennas. However in practice the number of transmit and receive antennas can be integer numbers 1 or more. With the two transmit antennas, the number of codes K can be up to twice the processing gain N. The number of bits, bₚ, per symbol transmitted over each spreading sequence is determined in accordance with the values identified by the Transport Format Combination number. In the current standards the same bit rate is allocated to each parallel channel if all the codes are given to the same user. The maximum total rate that can be achieved over the HSDPA MIMO system is therefore equal to

$${R}_{T} = \frac{{Kb}_{p}}{T}$$

bits per second. For a given transmission, as the number of parallel channels K and the transmission symbol period are fixed, the maximum data rate is determined by the number of bits bₚ per symbol. The transmitter control unit 111 and the receiver control unit 207 work together to determine the bit rate bₚ per symbol.

The signals from the transmitters over the channels 161,1 and 161,2 are received at the receiver via two receiving antennas. Each transmitter, receiver antenna pair have a channel impulse response associated with the transmission channel as those skilled in the art will appreciate. For two transmit and two receive antennas, there are a maximum total of four different channel impulse responses to be used in the system configuration. At the receiver (FIG. 2) the signals that are received from the two transmitter antennas 112 over the links 161,1 and 161,2 are fed to two chip matched filter receivers 201,1 and 201,2. The chip matched filtered signals are fed to the despreading units 202 and 203 from the chip matched filters 201,1 and 201,2 via the links 251 and 252 respectively. The despreading units 202 and 203 act in a manner that is well known to those skilled in the art of spread spectrum systems. The signals at the output despreading units 202 and 203 are fed to an adder 204 via the links 253 and 254. The receiver control unit 207 monitors the signal-to-noise ratio γₖ at the link 255 where the outputs 253 and 254 of the despreading units 202 and 203 are combined by the adder 204. The combined despreading units 202 and 203 have the effect of isolating the signals on the separate sub-channels and at the M-ary soft decoder 205 the information corresponding to noise corrupted versions of those at 104 are obtained when considering multipath interference free transmission. In schemes described in References [1, 2], the capacity comprising the HSDPA MIMO system is improved by jointly using the transmitter control unit 111 at the transmitter and the receiver control unit 207 at the receiver to adjust the data rate bₚ and also the transmission energy

$${E}_{k} ( {b}_{p} ) = \frac{{E}_{T}}{K}$$

for k=1, . . . , K to deliver different signal-to-noise ratios γₖ over k=1, . . . , K parallel channels. As those skilled in the art will appreciate the minimum energy E(bₚ) required to transmit the data at a rate bₚ bits per symbol over a sub-channel whilst achieving a sufficient signal to noise ratio γ*(bₚ)=Γ(2^{b}^{ₚ}−1) at the output of the despreading summation units 204 is given by

$$E ( {b}_{p} ) = \frac{2 {Γσ}^{2}}{{\vert {h}_{min} \vert}^{2}} ( {2}^{{b}_{p}} - 1 )$$

where |hₘᵢₙ|² is the channel gain Corresponding to the channel with the minimum channel gain of the sub-channels. γ*(bₚ) is the minimum signal-to-noise ratio required to transmit data at a rate bₚ and is known as the desired SNR.

In the current HSDPA MIMO systems, each of the K parallel channels is used to transmit the data at an equal rate bₚ if all the channels are assigned to a single user. As those in the art will appreciate, the control unit 207 at the receiver monitors the SNR γₖ at the summed outputs 204 of each pair of despreading units 202 and 203 using the hybrid ARQ scheme. The receiver control unit 207 communicates with the transmitter control unit 111 to achieve the transmission data rate bₚ which will satisfy the relationship

$$\frac{2 K Γ {σ}^{2}}{{\vert {h}_{min} \vert}^{2}} ( {2}^{{b}_{p}} - 1 ) \leq {E}_{T} < \frac{2 K Γ {σ}^{2}}{{\vert {h}_{min} \vert}^{2}} ( {2}^{{b}_{p + 1}} - 1 )$$

when allocated for a given total transmission energy E_{T}=TP_{T} where P_{T} is the available total transmission power. The total number of bits b_{T}=Kbₚ is then calculated. The transmitter control unit 111 informs the channel encoder units 102 and the M-ary modulation units 104 to use the appropriate channel encoding and modulation levels respectively for a given transmission data rate bₚ bits per symbol using the links 163 and 164. The transmitter control unit 111 sends the energy level

$$E ( {b}_{p} ) = \frac{2 {Γσ}^{2}}{{\vert {h}_{min} \vert}^{2}} ( {2}^{{b}_{p}} - 1 )$$

to the power control unit 107 and 108 to adjust the transmission signal levels at the links 157 and 158. The transmitter control unit 111 communicates with the receiver control unit 207 to exchange the information related to the number of channels to be used during the next transmission and the information related to the transmission bit rate bₚ and also the transmission energy

$$E ( {b}_{p} ) = \frac{{E}_{T}}{K}$$

information. The transmitter control unit 111 also sends a pilot signal via the two transmitter antennas 112,1 and 112,2. The receiver control unit 207 estimates the channel impulse responses for each pair of the transmit antenna 112,1 (and 112,2) and receiver chip matched filter 201,1 (and 201,2) antenna using received pilot signal. Using the channel impulse response estimates, the receiver control unit 207 formulates the channel convolution matrix

$$H = [ \begin{matrix}{H}_{1 , 1} & & {H}_{1 , 2} \\ & & \\ {H}_{2 , 1} & & {H}_{2 , 2}\end{matrix} ]$$

and also the receiver matched filter coefficients Q=HS=[\vec{q}₁ . . . \vec{q}_{K}], and the extended matched filter receiver signature sequence matrix Qₑ=[HS, H_{Prev}S, H_{Next}S] where for the SISO systems H_{Prev}=(J^{T})^{N}H and H_{Next}=J^{N}H and for the MIMO systems

$${H}_{Prev} = [ \begin{matrix}{( {J}^{T} )}^{N} {H}_{1 , 1} & & {( {J}^{T} )}^{N} {H}_{1 , 2} \\ & & \\ {( {J}^{T} )}^{N} {H}_{2 , 1} & & {( {J}^{T} )}^{N} {H}_{2 , 2}\end{matrix} ] and$$

$${H}_{Next} = [ \begin{matrix}{J}^{N} {H}_{1 , 1} & & {J}^{N} {H}_{1 , 2} \\ & & \\ {J}^{N} {H}_{2 , 1} & & {J}^{N} {H}_{2 , 2}\end{matrix} ] .$$

For the allocated energies, the receiver control unit 207 next formulates the receiver covariance matrix using C=QₑAₑ²Qₑ^{H}+2σ²I_{N}_{ᵣ}_{(N+L-1)} where Nᵣ is the number of receiver antennas. The receiver control unit 207 next calculates the despreading filter coefficients using the MMSE equalizer coefficients equation

$${\vec{w}}_{k} = \frac{{C}^{- 1} {\vec{q}}_{k}}{{q}_{k}^{H} {C}^{- 1} {\vec{q}}_{k}}$$

for k=1, . . . , K. The despreading filter coefficient vector is a 2(N+L−1) dimensional column vector. The receiver control unit 207 next formulates the 2(N+L−1)×K dimensional despreading filter matrix

$$W = [ \begin{matrix}{W}_{1} \\ {W}_{2}\end{matrix} ] = [ \begin{matrix}{\vec{w}}_{1} , & {\vec{w}}_{2} , & … & {\vec{w}}_{k} , & {\vec{w}}_{K}\end{matrix} ] .$$

The receiver control unit 207 forms two (N+L−1)×K dimensional despreading sequence matrices W₁=└\vec{w}_{1,1}, \vec{w}_{1,2}, . . . \vec{w}_{1,k}, \vec{w}_{1,K}┘ and W₂=└\vec{w}_{2,1}, \vec{w}_{2,2}, . . . \vec{w}_{2,k}, \vec{w}_{2,K}┘ and feeds the despreading filter coefficient \vec{w}_{1,k} for k=1, . . . , K to the despreading unit 202 and the despreading filter coefficient \vec{w}_{2,k} for k=1, . . . , K to the despreading unit 203 via the links 258. The receiver control unit 207 sends the modulation level information to the M-ary soft decoder unit 205 via the link 259 and the channel decoding information to the channel decoder 206 via the link 260. After the receiver control unit 207 loads the despreading units 202 and 203 and the M-ary soft decoder unit 205 and also the channel decoder 206, the signals received over channels 161,1 and 161,2 are despread by the despreading units 202 and 203. The signals, appearing at the outputs 255 of the adder units 204 which combine the signals appearing at the links 253 and 254 which are taken from the despreading units 202 and 203, are fed to the M-ary soft decoder units 205. The M-ary soft decoder unit 205 is linked to the channel decoder unit 206 via the link 256. The M-ary soft decoder unit 205 and the channel decoder unit 206 work together to produce the decoded data at the link 257 in a manner that is well known to those skilled in the art of digital transmission systems.

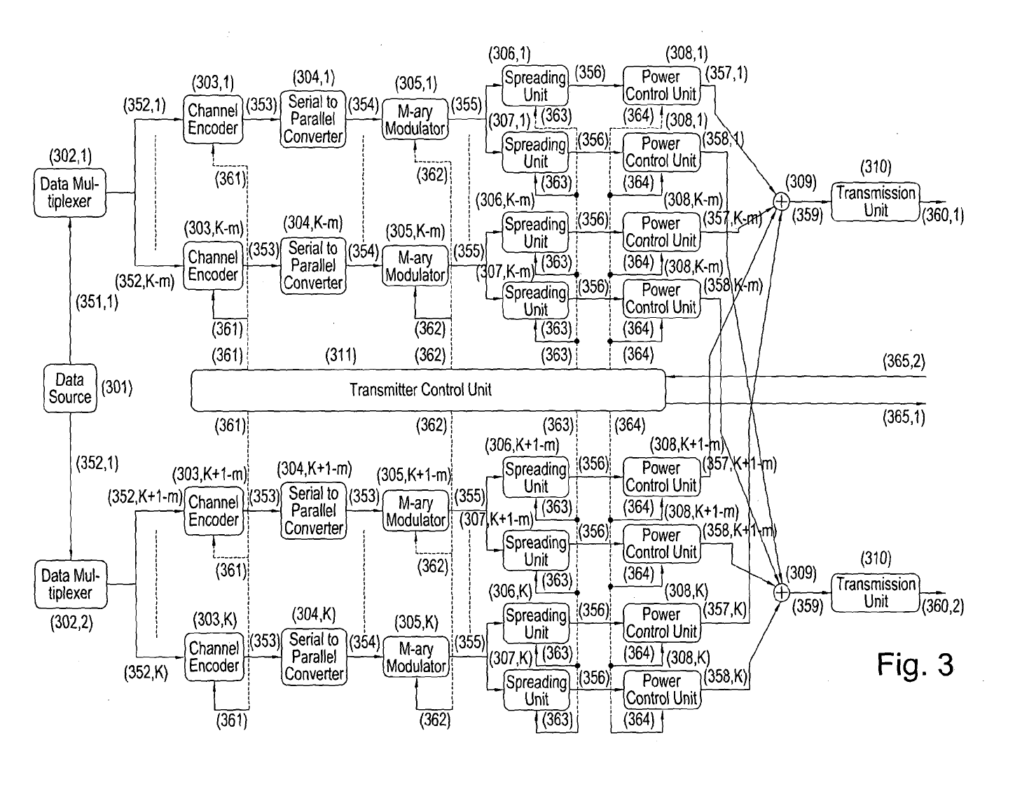

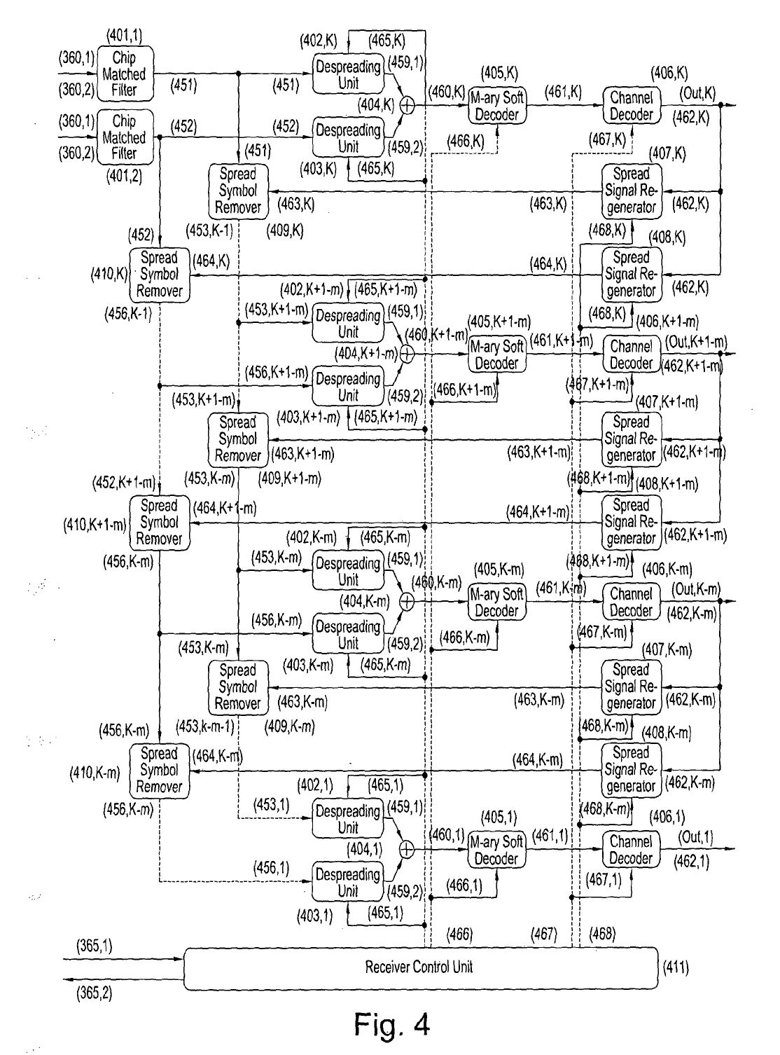

The principal elements of the transmitter and receiver structures considered in the present work are shown in FIGS. 3 and 4 respectively when using a system with a total K parallel channels. At the transmitter of the system one data source is considered where each data source 301 may correspond to a single user and the data is fed in blocks to two multiplexers 302 via the links 351. The operations performed on data from the source data are similar and for purpose of illustration will be restricted to the method of operation as applied to one multiplexer and one sub-channel receiver. The output of the multiplexer 302 at the top of FIG. 3 is fed to (K−m) parallel channels via the links 352,1 to 352, (K−m). The output from the multiplexer 302 at the bottom of FIG. 3 is fed to m channels via the links 352, (K+1−m) to 352, K. The operations performed on data over each channel are similar and for purposes of illustration, consideration will be restricted to the method of operation as applied to the first channel. At the multiplexer 302, the binary data is taken from the source in blocks in binary format or digits. These binary digits are fed to a channel encoder 303. The encoder 303 produces binary digits which are produced from the input data at 352 which are fed from the multiplexer 302. The resultant encoding increases the packet length. After the channel encoding the binary digits appearing at the link 353 are fed to the serial-to-parallel converter 304 which produces b bits of data in parallel at the link 354. The data appearing at the link 354 are fed into an M-ary modulation unit 305 of a well known type in the art. The modulation unit 305 operates using a total M constellation points which is determined by the transmitter control 311. The M-ary modulation unit 305 takes in sequence of a total of b=log₂ M binary digits of data every symbol period from the incoming data at 354. The modulation unit produces one of M symbols at 355 for each b binary digit. When combining the channel encoding rate and the number of bits per symbol b, it is possible to generate one of bₚ bits per symbol for p=1, . . . , P over each sub-channel. The signals appearing at the link 355 are then each fed to the spreading units 306 and 307 to multiply each M-ary modulated symbol by the spreading sequences allocated to the spreading units 306 and 307. It will be appreciated that the spreading code sequence differs for each of the sub-channels employed by each channel and also differs from channel to channel. The signals appearing at the outputs links 356 of the spreading units 306 and 307 (“the chips”, as they are known in the art), are then fed to a power control unit 308 which adjusts the energy for each symbol before transmission. The energy level used by each sub-channel is determined by the transmitter control unit 311. Initially the transmitter operation will be described for the SIC based receiver arrangement.

The transmitter control unit 311 communicates with the SIC receiver control unit 411 at the receiver over the uplink 365,2 and over the downlink 365,1. The transmitter uses two discrete rates bₚ and bₚ₊₁ bits per symbols over two groups of channels. The transmitter control unit 311 uses the link 361 to send the information related to the transmission rate bₚ and bₚ₊₁ bits per symbols and also the number of symbols per packet to be used for each sub-channel to each channel encoder 303. The transmitter control unit 311 uses the link 362 to send the modulation level information b bits to the M-ary modulation unit 305. The transmitter control unit 311 uses the links 363 to communicate with the spreading units 306 and 307. The transmitter control unit 311 uses the link 364 to communicate with the power control units 308. There are a total of P symbols available for use to generate bₚ bits for p=1, . . . , P. The transmitter control unit 311 uses the control channels 365,1 and 365,2 to obtain the information related to the multipath channel impulse responses, the channel path gain, and also the noise variance σ² from the receiver control unit 411 in a manner that is well known to those experienced in the field of digital data transmission. The transmitter control unit 311 then calculates the spreading signals to be used if the objective is to use the optimum transmission signature sequences. Otherwise if a given set of signature sequences to be used the transmitter control units 311 allocates the transmission spreading sequences to the spreading units 306 and 307. The transmitter control unit 311 then uses the signature sequence set S=└\vec{s}₁ . . . \vec{s}_{K*}┘ and the measured channel impulse response matrix

$$H = [ \begin{matrix}{H}_{1 , 1} & & {H}_{1 , 2} \\ & & \\ {H}_{2 , 1} & & {H}_{2 , 2}\end{matrix} ]$$

which is obtained from the control channel information exchange between the transmitter control unit 311 and the receiver control unit 411 via the links 3651, and 365,2 in a manner that is well known to those experienced in the art of data transmission. The transmitter control unit 311 next formulates the channel Gramian matrix H^{H}H and calculates the optimum transmission signature sequences, if required, which are given in terms of the Gram matrix H^{H}H=V_{H}D_{H}V_{H}^{H} where D_{H} is the diagonal matrix of Eigen values and V_{H} is the matrix of Eigen vectors. The optimum spreading sequence matrix is obtained by S=└\vec{s}₁ . . . \vec{s}_{K}┘=V_{H}. The transmitter control unit 311 then calculates the channel gains of the transmission system to be |hₖ|²=[Q^{H}Q]_{k,k} for k−1, . . . , K where the receiver matched filter coefficients are given by Q=HS=[\vec{q}₁ . . . \vec{q}_{K}]. The transmitter control unit 311 next calculates the optimum number of channels K* to be used by employing the optimum signature sequences and the channel gains and the water filling method described earlier. The transmitter control unit 311 then reorders the signature sequence matrix S=└\vec{s}₁ . . . \vec{s}_{K}┘ such that the resultant channel gains |hₖ|²=[Q^{H}Q]_{k,k} of the transmission system appear in a descending order for k=1, . . . , K. The transmitter control unit 311 then truncates the number of columns of the spreading sequence to be same as the optimum number of channels K*. The transmitter control unit 311 then reorders the signature sequence matrix S=└\vec{s}₁ . . . \vec{s}_{K}┘ such that the resultant channel gains appear in an ascending order for k=1, . . . , K. The resultant 2N×K* signature sequence matrix S=└\vec{s}₁ . . . \vec{s}_{K*}┘ is then re-configured by the transmitter control unit 311 such that

$$S = [ {\vec{s}}_{1} … {\vec{s}}_{{K}^{*}} ] = [ \begin{matrix}{S}_{1} \\ {S}_{2}\end{matrix} ] .$$

The transmitter control unit 311 then uses the signature sequences given by the N×K* dimensional matrices S₁=└\vec{s}_{1,1} . . . \vec{s}_{1,K*}┘ and S₂=└\vec{s}_{2,1} . . . \vec{s}_{2,K*}┘ to load the first K* spreading units 306 and 307 respectively via the link 363. The remaining K−K* spreading units are then loaded with zero coefficients by the transmitter control unit 311.

The transmitter control unit 311 then formulates the receiver matched filter coefficients Q=HS=[\vec{q}₁ . . . \vec{q}_{K}], and the extended matched filter receiver signature sequence matrix Qₑ=[HS, H_{Prev}S, H_{Next}S] where for the SISO systems H_{Prev}=(J^{T})^{N}H and H_{Next}=J^{N}H and for the MIMO systems

$${H}_{Prev} = [ \begin{matrix}{( {J}^{T} )}^{N} {H}_{1 , 1} & & {( {J}^{T} )}^{N} {H}_{1 , 2} \\ & & \\ {( {J}^{T} )}^{N} {H}_{2 , 1} & & {( {J}^{T} )}^{N} {H}_{2 , 2}\end{matrix} ] and$$

$${H}_{Next} = [ \begin{matrix}{J}^{N} {H}_{1 , 1} & & {J}^{N} {H}_{1 , 2} \\ & & \\ {J}^{N} {H}_{2 , 1} & & {J}^{N} {H}_{2 , 2}\end{matrix} ] .$$

The transmitter control unit 311 then uses the available total transmission energy E_{T} to calculate the covariance matrix

$$C = \frac{{E}_{T}}{{K}^{*}} {Q}_{e} {Q}_{e}^{H} + 2 {σ}^{2} {I}_{Nr ( N + L - 1 )}$$

and the system value

$${λ}_{k} = \frac{{E}_{T}}{{K}^{*}} {\vec{q}}_{k}^{H} {C}^{- 1} {\vec{q}}_{k} for k = 1 , … , {K}^{*} ,$$

the total system value λ_{T,max}=Σₖ₌₁^{K*}λₖ and also the mean system value

$${λ}_{mean} = \frac{{λ}_{T , max}}{{K}^{*}} .$$

The transmitter control unit 311 next calculates the transmission bit rate bₚ such that if the rate bₚ is allocated to all the channels the inequality λ*(bₚ)≦λₘₑₐₙ=λ*(bₚ₊₁) is satisfied. The transmission control unit 311 then finds the highest integer m value which satisfies the inequality (K*−m)λ*(bₚ)+mλ*(bₚ₊₁)<λ_{T,max} when a total of m channels are used to transmit data at the higher rate bₚ₊₁. The transmitter control unit 311 next puts the first (K*−m) spreading units 306 and 307 in the upper group of FIG. 3 and the remaining m spreading units in the lower group of FIG. 3. The transmitter control unit 311 then uses the SIC iterative energy calculation method by initially forming the covariance matrix C₀⁻¹=(2σ²)⁻¹I_{N}_{ᵣ}_{(N+L-1)}. For the calculations of energies Eₖ for k=1, . . . , K, the transmitter control unit 311 first calculates the distance vectors \vec{d}=Cₖ₋₁⁻¹=\vec{q}ₖ, \vec{d}₁=Cₖ₋₁⁻¹=\vec{q}_{k,1} and \vec{d}₂=Cₖ₋₁⁻¹=\vec{q}_{k,2} where \vec{q}_{k,1}=H_{Prev}\vec{s}ₖ and \vec{q}_{k,2}=H_{Next}\vec{s}ₖ. The transmitter control unit 311 then calculates the weighting factors ξ=\vec{d}^{H}\vec{q}ₖ, ξ₁=\vec{d}₁^{H}\vec{q}_{k,1}, ξ₂=\vec{d}₂^{H}\vec{q}_{k,2}, ξ₃=\vec{d}^{H}\vec{q}_{k,1} and ξ₄=\vec{d}^{H}\vec{q}_{k,2}. For the first (K*−m) channels, the transmitter control unit 311 uses the data rate yₖ=bₚ bits per symbol. For the remaining m channels, the transmitter control unit 311 uses yₖ=bₚ₊₁ bits per symbol for k=(K*+1−m), . . . , K* to calculate the energies iteratively using

$${E}_{k , i} = \frac{Γ ( {2}^{{y}_{k}} - 1 )}{ξ - {E}_{k , ( i - 1 )} ( \frac{{\vert {ξ}_{3} \vert}^{2}}{1 + {E}_{k , ( i - 1 )} {ξ}_{1}} + \frac{{\vert {ξ}_{4} \vert}^{2}}{1 + {E}_{k , ( i - 1 )} {ξ}_{2}} )}$$

and also the energy E_{k,(i-1)} at channel k itself. The iteration number i has the maximum number of iterations equal to Iₘₐₓ. Once the transmitter control unit 311 calculates the transmission energy Eₖ for k=1, it next calculates the inverse covariance matrix Cₖ⁻¹ by further defining the weighting factors

$$ζ = \frac{{E}_{k}}{1 + Γ ( {2}^{{b}_{P}} - 1 )} , {ζ}_{1} = \frac{{E}_{k}}{1 + {E}_{k} {ξ}_{1}} and {ζ}_{2} = \frac{{E}_{k}}{1 + {E}_{k} {ξ}_{2}}$$

and using the iterative relationship

$${C}_{k}^{- 1} = {C}_{k - 1}^{- 1} - ζ \vec{d} {\vec{d}}^{H} - ( {ζ}_{1} + ζ {ζ}_{1}^{2} {\vert {ξ}_{3} \vert}^{2} ) {\vec{d}}_{1} {\vec{d}}_{1}^{H} - ( {ζ}_{2} + ζ {ζ}_{2}^{2} {\vert {ξ}_{4} \vert}^{2} ) {\vec{d}}_{2} {\vec{d}}_{2}^{H} + ζ {ζ}_{1} ( {ξ}_{3} \vec{d} {\vec{d}}_{1}^{H} + {{ξ}_{3}^{*} ( \vec{d} {\vec{d}}_{1}^{H} )}^{H} ) + ζ {ζ}_{2} ( {ξ}_{4} \vec{d} {\vec{d}}_{2}^{H} + {{ξ}_{4}^{*} ( \vec{d} {\vec{d}}_{2}^{H} )}^{H} ) - ζ {ζ}_{1} {ζ}_{2} ( {ξ}_{3} {ξ}_{4}^{*} {\vec{d}}_{2} {\vec{d}}_{1}^{H} + {( {ξ}_{3} {ξ}_{4}^{*} )}^{*} {( {\vec{d}}_{2} {\vec{d}}_{1}^{H} )}^{H} )$$

by increasing the channel number from k=1 to k=K* at increments of 1. The transmitter control 311 then loads the transmission energies Eₖ for k=1, . . . , K* to the transmission power control units 308 via the links 364.

After the transmitter control unit 311 completes loading the channel encoders 303, the M-ary modulation units 305, the spreading units 306 and 307 and also the power control units 308 with the appropriate control parameters, the binary bits are processed by units 302, 303, 304, 305 306, 307 and 308, the signals of the m high data rate, and the (K*−m) low data rate channels appearing at 357 and 358 are then added together in the adders 309 prior to feeding them to the transmitter antennas 310 before transmitting them over the channel 360. It will be appreciated that pass-band modulation and demodulation may be involved and FIGS. 3 and 4 represent the equivalent baseband schemes in the current patent.

The transmitter control unit 311, then sends the spreading sequence matrices S₁=└\vec{s}_{1,1} . . . \vec{s}_{1,K*}┘ and S₂=└\vec{s}_{2,1} . . . \vec{s}_{2,K*}┘, and also the number of optimum channels K* and the allocated energies Eₖ for k=1, . . . , K* to the receiver control unit 411 via the control channels 365,1 and 365,2.

FIG. 4 shows an illustration of the receiver of the SIC MIMO system, operable with the transmitter described above. At the link 360, the signals are received via the two receiver antennas from the channel and are fed to the chip matched filters 401 which operate in a manner that is well known to those experienced in the art of digital data transmission. The signals appearing at the links 451 and 452, which are the outputs of the chip matched filters 401, are fed to the despreading units 402 and 403 respectively. The chip matched filtered signals at the links 451 and 452 are also fed to the spread symbol removers 409 and 410. The first set of despreading units 402 and 403 correspond to the sub-channel K* and operate as an inverse of the spread signal generator units 306 and 307 at the transmitter in a manner that is well known to those skilled in the art of spread spectrum communication. The receiver control unit 411 operates in cooperation with the transmitter control unit 311 to estimate the channel impulse response for each of the transmitter receiver antenna pairs. The receiver control unit 411 feeds back the channel impulse response information to the transmitter control unit 311 via the control channels 365,1 and 365,2. The transmitter control unit 311 either uses a predefined set of spreading signature sequences or calculates the optimum spreading signature sequence for the estimated channel impulse responses as described in the transmitter operation part. If the optimum signature sequences are used, the transmitter control unit 311 transmits the spreading sequence matrix S=└\vec{s}₁ . . . \vec{s}_{K*}┘ information and the allocated energies Eₖ for k=1, . . . , K* and the optimum number of channel K* information and also the data rates bₚ, bₚ₊₁ to be used in the low and high data rate channels and also the number m in the high data rate channels to the receiver control unit 411 via the links 365,1 and 365,2 in a manner that is well known to those experienced in the art of data communication systems. The receiver control unit 411 formulates the channel impulse response convolution matrix

$$H = [ \begin{matrix}{H}_{1 , 1} & {H}_{1 , 2} \\ {H}_{2 , 1} & {H}_{2 , 2}\end{matrix} ]$$

using the channel impulse responses estimated from the received pilot signals. The receiver control unit 411 also formulates the matrices

$${H}_{Prev} = [ \begin{matrix}{( {J}^{T} )}^{N} {H}_{1 , 1} & {( {J}^{T} )}^{N} {H}_{1 , 2} \\ {( {J}^{T} )}^{N} {H}_{2 , 1} & {( {J}^{T} )}^{N} {H}_{2 , 2}\end{matrix} ] and$$

$${H}_{Next} = [ \begin{matrix}{J}^{N} {H}_{1 , 1} & {J}^{N} {H}_{1 , 2} \\ {J}^{N} {H}_{2 , 1} & {J}^{N} {H}_{2 , 2}\end{matrix} ]$$

for the MIMO systems and corresponding matrices for the SISO systems. The receiver control unit 411 next formulates the receiver matched filter coefficients Q=HS=[\vec{q}₁ . . . \vec{q}_{K}] and also the vectors \vec{q}_{k,1}=H_{Prev}\vec{s}ₖ, \vec{q}_{k,2}=H_{Next}\vec{s}ₖ and then sets the initial covariance matrix inverse to be

$${C}_{0}^{- 1} = {( 2 {σ}^{2} )}^{- 1} {I}_{{N}_{r} ( N + L - 1 )} .$$

For k=1, . . . K*, the receiver control unit 411 then iteratively calculates the distance vectors \vec{d}=Cₖ₋₁⁻¹\vec{q}ₖ, \vec{d}₁=Cₖ₋₁⁻¹\vec{q}_{k,1} and \vec{d}₂=Cₖ₋₁⁻¹\vec{q}_{k,2} and also the weighting factors ξ=\vec{d}^{H}\vec{q}ₖ, ξ₁=\vec{d}₁^{H}\vec{q}_{k,1}, ξ₂=\vec{d}₂^{H}\vec{q}_{k,2}, ξ₃=\vec{d}^{H}\vec{q}_{k,1} and

$${ξ}_{4} = {\vec{d}}^{H} {\vec{q}}_{k , 2} and ζ = \frac{{E}_{k}}{1 + Γ ( {2}^{{b}_{p}} - 1 )} , \\ {ζ}_{1} = \frac{{E}_{k}}{1 + {E}_{k} {ξ}_{1}} and {ζ}_{2} = \frac{{E}_{k}}{1 + {E}_{k} {ξ}_{2}}$$

and also the convolution matrix inverse using

$${C}_{k}^{- 1} = {C}_{k - 1}^{- 1} - ζ \vec{d} {\vec{d}}^{H} - ( {ζ}_{1} + ζ {ζ}_{1}^{2} {\vert {ξ}_{3} \vert}^{2} ) {\vec{d}}_{1} {\vec{d}}_{1}^{H} - ( {ζ}_{2} + ζ {ζ}_{2}^{2} {\vert {ξ}_{4} \vert}^{2} ) {\vec{d}}_{2} {\vec{d}}_{2}^{H} + ζ {ζ}_{1} ( {ξ}_{3} \vec{d} {\vec{d}}_{1}^{H} + {{ξ}_{3}^{*} ( \vec{d} {\vec{d}}_{1}^{H} )}^{H} ) + ζ {ζ}_{2} ( {ξ}_{4} \vec{d} {\vec{d}}_{2}^{H} + {{ξ}_{4}^{*} ( \vec{d} {\vec{d}}_{2}^{H} )}^{H} ) - ζ {ζ}_{1} {ζ}_{2} ( {ξ}_{3} {ξ}_{4}^{*} {\vec{d}}_{2} {\vec{d}}_{1}^{H} + {( {ξ}_{3} {ξ}_{4}^{*} )}^{*} {( {\vec{d}}_{2} {\vec{d}}_{1}^{H} )}^{H} ) .$$

The receiver control unit 411 next calculates the despreading filter coefficients using the MMSE equalizer coefficients equation

$${\vec{w}}_{k} = \frac{{C}^{- 1} {\vec{q}}_{k}}{{\vec{q}}_{k}^{H} {C}^{- 1} {\vec{q}}_{k}}$$

for k=1, . . . , K*. The despreading filter coefficient vector is a 2(N+L−1) dimensional column vector. The receiver control unit 411 next formulates the 2(N+L−1)×K* dimensional despreading filter matrix

$$W = [ \begin{matrix}{W}_{1} \\ {W}_{2}\end{matrix} ] = [ \begin{matrix}{\vec{w}}_{1} , & {\vec{w}}_{2} & … & {\vec{w}}_{k} , & {\vec{w}}_{{K}^{*}}\end{matrix} ]$$

The receiver control unit 411 forms two (N+L−1)×K* dimensional despreading sequence matrices W₁=└\vec{w}_{1,1}, \vec{w}_{1,2}, . . . \vec{w}_{1,k}, \vec{w}_{1,K*}┘ and W₂=└\vec{w}_{2,1}, \vec{w}_{2,2}, . . . \vec{w}_{2,k}, \vec{w}_{2,K*}┘ and feeds the despreading filter coefficient \vec{w}_{1,k} for k=K*, . . . , 1 to the despreading units 402 and the despreading filter coefficient \vec{w}_{2,k} for k=K*, . . . , 1 to the despreading unit 403 via the links 452 starting from the despreading units appearing at the top of FIG. 4.

The despreading units 402 and 403 act in a manner that is well known to those skilled in the art of spread spectrum systems. The signals at the output of the despreading units 402 and 403 are fed to an adder 404 via links 459,1 and 459,2 respectively. The combined despreading units 402 and 403 have the effect of isolating the signals on the separate channels. The receiver control unit 411 sends the modulation level information to the M-ary soft decoder unit 405 via the link 466 and the channel decoding information to the channel decoder unit 406 via the link 467. After the receiver control unit 411 loads the despreading units 402 and 403 and the M-ary soft decoder unit 405 and also the channel decoder 406, the signals received over channels 360 are despread by the despreading units 402 and 403. The signals, appearing at the output 460 of the adder 404 which combines the signals appearing at the links 459,1 and 459,2 originating from the despreading units 402 and 403, are fed to the M-ary soft decoder units 405 via the link 461. The M-ary soft decoder unit 405 is linked to the channel decoder unit 406 via the link 461. The M-ary soft decoder unit 405 and the channel decoder unit 406 work together to produce the decoded data at the link 457 for the sub-channel K* in a manner that is well known to those skilled in the art of digital communication.

The detected data appearing at 462 are fed to the spread symbol generator units 407 and 408. The control unit 411 loads the spread symbol generator units 407 and 408 with the appropriate channel encoder information, modulation level information and also the channel impulse response matrices H, H_{Prev} and H_{Next} via the link 468. The spread symbol generator units 407 and 408 use the detected information appearing at the link 462 to produce versions of the signals appearing at the outputs 357, K* and 358, K* after having gone through the transmission channel 360 as they appear at the outputs 451 and 452 of the receiver chip matched filters 401. The signals appearing at the outputs 463 and 464 of the spreading symbol generator units 407 and 408 are fed to the spread symbol remover units 409 and 410. The spread symbol removal units 409 and 410 operate in a manner that is well known to those experienced in the field of successive interference cancellation systems. The signals at the links 453 and 456 which are the outputs of the symbol remover units 409 and 410 are then fed to the next set of despreading units 402 and 403. The detection process is then repeated for the next set of received data sequences corresponding to the channels number k going from k=K*−1 to k=1.

The operations performed on the received signals over each sub-channel are similar and for the purpose off illustration, consideration is restricted to the method operation as applied to the sub-channel K*.

### Applications

The techniques and embodiments described above are suitable for the transmission of data in a mobile network, e.g. in a 3G CDMA network. It should be noted, however, that their application is not limited to CDMA, and could, for example, be used in spreading and despreading units or modulators for non-CDMA applications.

### Technical Construction

The “units” in the transmitter, such as the channel encoder, the M-ary modulation unit, the spreading unit, the power control unit, the resource allocation unit and the adder, may be provided as separate pieces of equipment or discrete components or circuits that are communicatively connected in order to enable the signal processing methods described herein to be performed. Alternatively, two or more of the “units” may be integrated into a single piece of equipment, or provided as a single component or circuit. In further alternatives, one or more of the “units” may be provided by a computer processor programmed to provide equivalent functionality.

Similarly, the “units” in the receiver, such as the de-spreading unit, the buffer unit, the decoder units, and the control unit may be provided as separate pieces of equipment or discrete components or circuits that are communicatively connected in order to enable the signal processing methods to be performed. Alternatively, two or more of the “units” may be integrated in a single piece of equipment, or provided as a single component or circuit. In further alternatives, one or more of the “units” may be provided by a computer processor programmed to provide equivalent functionality.

In some instances, the sequence of the units in the transmitter or the receiver may be changed, as those skilled in the art will appreciate.

### REFERENCES

[1] 3GPP TS 25.214: Physical Layer Procedure (FDD), V10.1.0 ed., 3GPP, December 2010.
[2] C. Mehlfuhrer, S. Caban, and M. Rupp, “Measurement-based performance evaluation of MIMO HSDPA,” IEEE Transactions on Vehicular Technology, vol. 59, no. 9, pp. 4354-4367, 2010
[3] US 2011/0019629, “Selecting a Transmission Technology”, 27 Jan. 2011.
[4] US 2010/0296446, “Dynamic switching between mimo and dc hsdp”, 25 Nov. 2010.
[5] US 2010/0238886, “Single channelization code harq feedback for dc-hsdpa+mimo”, 23 Sep. 2010.
[6] US 2009/0161690, “Method and system for channel estimation in a single channel (sc) multiple-input multiple-output (mimo) system comprising two-transmit (2-tx) and multiple-receive (m-rx) antennas for wcdma/hsdpa)”, 25 Jun. 2009.
[7] US 2009/0135893, “Method and system for weight determination in a spatial multiplexing mimo system for wcdma/hsdpa”, 28 May 2009.
[8] US 2006/0072514, “Method and system for single weight (sw) antenna system for spatial multiplexing (sm) mimo system for wcdma/hsdpa”, 6 Apr. 2006.
[9] US 2006/0072607, “Method and system for channel estimation in a single channel (sc) multiple-input multiple-output (mimo) system comprising two-transmit (2-tx) and multiple-receive (m-rx) antennas for wcdma/hsdpa”, 6 Apr. 2006.
[10] US 2006/0072629, “Method and system for implementing a single weight (sw) single channel (sc) mimo system with no insertion loss”, 6 Apr. 2006.
[11] US 2010/0254315, “Method for indicating modulation mode in high speed downlink packet accessing”, 7 Oct. 2010.
[12] US 2010/0234058, “Channel quality prediction in hsdpa systems”, 16 Sep. 2010.
[13] US 2010/0208635, “Method and system for transport block size signaling based on modulation type for hsdpa”, 19 Aug. 2010.
[14] US 2010/0322224, “Server, terminal and method for end to end channel capacity estimation in high speed downlink packet access network”, 23 Dec. 2010.
[15] US 2010/0311433, “Allocation and priority handling of uplink and downlink resources”, 9 Dec. 2010.
[16] US 2010/0298018, “Addressing available resources for hsdpa accesses”, 25 Nov. 2010.
[17] US 2008/0299985, “Downlink traffic channel resource allocation method and data transmission method for multi-carrier hsdpa”, 4 Dec. 2008.
[18] US 2007/0091853, “Power control for high speed packet data transmission”, 26 Apr. 2007.
[19] US 2007/0072612, “Hsdpa wireless communication system”, 29 Mar. 2007.
[20] US 2006/0252446, “Method and apparatus for setting a power limit for high speed downlink packet access services”, 9 Nov. 2006.
[21] US 2006/0246939, “Transmission power control for hsdpa connections”, 2 Nov. 2006.
[22] WO 2010/106330, “Bit Loading method and Apparatus for Multicode Parallell Communication Channel”, 23 Sep. 2010.
[23] Bessem Sayadi, Stefan Atanman and Inbar Fijalkow, “Joint Downlink Power Cotrol and Multicode Receivers for Downlink Transmission in High Speed UMTS”, EUROSIP Journal on Wireless Networking, Vol. 2006, pp 1-10 May 2006.
[24] G. Forney Jr and G. Ungerboeck, “Modulation and coding for linear Gaussian channels,” IEEE Transactions on Information Theory, vol. 44, no. 6, pp. 2384-2415, 1998.
[25] Mustafa K. Gurcan, Hadhrami Ab Ghani, Jihai Zhou and Anusorn Chungtragarn, “Bit Energy Consumption Minimization for Multi-path Routing in Ad-hoc Networks”, The Computer Journal, 2011, Vol: 6, Pages: 944-959.
[26] Ghani H A, Gurcan M K, He Z, Cross-layer Optimization with Two-group Loading for Ad-hoc Networks, 26th International Symposium on Computer and Information Sciences, 2011.
[27] Gurcan M, Ma I, Ghani H A, et al, Complexity Reduction for Multi-hop Network End-to-End Delay Minimization, 26th International Symposium on Computer and Information Sciences, 2011.
[28] J. Zhou, M. K. Gurcan, and A. Chungtragarn, “Energy-aware Routing with Two-group Allocation in Ad Hoc Networks”, proceedings of International Conference ISCIS 2010, September 2010.
[29] Z. He, M. K. Gurcan, Hadhrami Ab Ghani, “Time-Efficient Resource Allocation Algorithm over HSDPA in Femtocell Networks”, proceedings of international conference PIMRC 2010, Femtocell workshop September 2010.
[30] M. K. Gurcan and Hadhrami Ab. Ghani, “Small-sized Packet Error Rate Reduction Using Coded Parity Packet Approach”, proceedings of IEEE international Conference PIMRC 2010 September 2010.
[31] Hadhrami Ab. Ghani, M. K. Gurcan, Zhenfeng He, “Two-Group Resource Allocation With Channel Ordering And Interference Cancellation”, proceedings of IEEE international conference WCNC 2010 April 2010.
[32] Z. He and M. K. Gurcan “Optimized Resource Allocation of HSDPA Using Two Group Allocation in Frequency Selective Channel”, proceedings of IEEE International conference on Wireless communication and Signal Processing conference WSCSP 2009.
[33] Jihai Zhou and M. K. Gurcan, “An Improved Multicode CDMA Transmission Method for Ad Hoc Networks”, proceedings of IEEE international conference WCNC 2009.
[34] Z. He and M. K. Gurcan, “The Rate Adaptive Throughput Maximization in PAM-Modulated Overloaded System”, proceedings of IEEE international conference WCNC 2009.
[35] Hadhrami Ab. Ghani and M. K. Gurcan, “Rate Multiplication and Two-group Resource Allocation in Multi-code CDMA Networks”, proceedings of IEEE international Conference PIMRC 2009.
[36] Z. He and M. K. Gurcan, “Optimizing Radio Resource Allocation in HSDPA Using 2 Group Allocation”, proceedings of IEEE international conference IWCNC 2009, Germany 2009.

1. A method of transmitting data over a radio data transmission system having a plurality of K parallel single-input single-output or multiple-input multiple-output channels, the method comprising transmitting data at a rate bₚ bits per symbol over a first group of (K−m) channels, and at a rate bₚ₊₁ bits per symbol over a second group of m channels, by spreading the data using a number of signature sequences S;
wherein the total number of signature sequences is greater than one, and is equal to the multiplication of the number of receiving antennas and the processing gain N used to spread the system signals;
wherein the spreading signature sequences S are determined using the Gramian matrices Q=H^{H}H of the channel impulse responses of the frequency selective multipath radio channels,
where the channel impulse response matrix H is obtained by forming the matrix
$$H = [ \begin{matrix}{H}_{1 , 1} & {H}_{1 , 2} \\ {H}_{2 , 1} & {H}_{2 , 2}\end{matrix} ]$$
using the specific channel impulse response matrix H_{i,j} which is defined as the multipath convolution matrix for a pair of transmitting antenna i and receiving antenna j, where i and j are integer numbers one or more,
and where the signature sequences S are obtained by decomposing the Gramian matrix Q into its Eigen vectors V as Q=VDV^{H}, where D is the matrix of Eigen values, and then by setting S=V;
wherein the optimum number of transmission channels is identified by using the water filling method where the signature sequence matrix S is ordered such that the channel gains |hₖ|², which are diagonal elements of D, appear in a descending order and the matched filter channel-SNIR gₖ for channel k is calculated using
$${g}_{k} = \frac{{\vert {h}_{k} \vert}^{2}}{2 {σ}^{2}}$$
for k=1, . . . , K where 2σ² is the noise per channel for the system with
$${σ}^{2} = \frac{{N}_{0}}{2}$$
for the two sided noise power spectral density of
$$\frac{{N}_{0}}{2} ;$$
and
wherein the optimum number, K*, of the signature sequences to be used is identified by initially setting K* to be K*=K and by calculating the water filling energies
$${E}_{k} = \frac{1}{{K}^{*}} [ {E}_{T} + \frac{1}{Γ} {\sum }_{k = 1}^{{K}^{*}} \frac{1}{{g}_{k}} ] = \frac{1}{Γ {g}_{k}}$$
for k=1, . . . , K* and then by testing the energy E_{K*}, for the last channel K*, to check if the energy is negative and for the negative energy case the optimum number K* is set to be (K*−1) and the energy calculation process is repeated until all energies are positive and for the resultant K* channels the signature sequences S=[\vec{s}₁ . . . \vec{s}_{K*}] are re-ordered such that the corresponding channel gains |hₖ|² appear in an ascending order and the despreading sequence matrix is reorganized such that
$$S = [ {\vec{s}}_{1} … {\vec{s}}_{{K}^{*}} ] = [ \begin{matrix}{S}_{1} \\ {S}_{2}\end{matrix} ]$$
where the signature sequences given by the N×K* dimensional matrices S₁=└\vec{s}_{1,1} . . . \vec{s}_{1,K*}┘ are used to load the first K* spreading units attached to a first transmitting antenna and S₂=└\vec{S}_{2,1} . . . \vec{s}_{2,K*}┘ are used to load the second K* spreading units attached to a second transmitting antenna.

2. A method as claimed in claim 1, further comprising determining the optimum data rate bₚ used to transmit data in the first group of (K−m) channels, by:
calculating the system values λₖ=Eₖ\vec{q}ₖ^{H}C⁻¹\vec{q}ₖ, one or more transmitters having total available energy E_{T}, which is considered to be equally distributed among K* parallel channels, to calculate the total system
$${λ}_{T , max} = \frac{{E}_{T}}{{K}^{*}} {\sum }_{k = 1}^{{K}^{*}} {q}_{k}^{\to H} {C}^{- 1} {\vec{q}}_{k}$$
and the mean system value as
$${λ}_{mean} = \frac{{λ}_{T , max}}{{K}^{*}} ;$$
obtaining the optimum transmission rate bₚ by satisfying the inequality λ*(bₚ)≦λₘₑₐₙ<λ*(bₚ₊₁) where the target system value for the first (K*−m) channels is
$${λ}^{*} ( {b}_{p} ) = \frac{Γ ( {2}^{{b}_{p}} - 1 )}{1 + Γ ( {2}^{{b}_{p}} - 1 )}$$
and that for the remaining m channels is
$${λ}^{*} ( {b}_{p + 1} ) = \frac{Γ ( {2}^{{b}_{p + 1}} - 1 )}{1 + Γ ( {2}^{{b}_{p + 1}} - 1 )} ,$$
in which the term Γ is the gap value, the covariance matrix is given by
$$C = \frac{{E}_{T}}{{K}^{*}} {Q}_{e} {Q}_{e}^{H} + 2 {σ}^{2} {I}_{Nr ( N + L - 1 )} ,$$
the receiver matched filter coefficients are given by Q=HS=[\vec{q}₁ . . . \vec{q}_{K}], and the extended matched filter receiver signature sequence matrix is given by Q=[HS, H_{Prev}S, H_{Next}S],
and wherein, for single-input single-output systems, H_{Prev}=(J^{T})^{N}H and H_{Next}=J^{N}H,
and for multiple-input multiple-output systems,
$${H}_{Prev} = [ \begin{matrix}{( {J}^{T} )}^{N} {H}_{1 , 1} & & {( {J}^{T} )}^{N} {H}_{1 , 2} \\ {( {J}^{T} )}^{N} {H}_{2 , 1} & & {( {J}^{T} )}^{N} {H}_{2 , 2}\end{matrix} ] and$$
$${H}_{Next} = [ \begin{matrix}{J}^{N} {H}_{1 , 1} & & {J}^{N} {H}_{1 , 2} \\ {J}^{N} {H}_{2 , 1} & & {J}^{N} {H}_{2 , 2}\end{matrix} ] ,$$
for which J is an ((N+L−1)×(N+L−1))-dimensional matrix formed by
$$J = [ \begin{matrix}{0}_{1 \times ( N + L - 2 )} & 0 \\ {I}_{( N + L - 2 )} & {0}_{( N + L - 2 ) \times 1}\end{matrix} ]$$
where the term N is the spreading sequence length and L is the channel impulse response length;
the method further comprising determining the number of channels m by finding the highest integer value satisfying the inequality (K*−m)λ*(bₚ)+mλ*(bₚ₊₁)<λ_{T,max}, for which the total transmission rate for K* parallel channels is R_{T}=(K*−m)bₚ+mbₚ₊₁ bit per symbol.

3. A method as claimed in claim 2, further comprising determining the energies to be allocated to the first and second groups of channels in order to maximize the total transmission rate R_{T}=(K*−m)bₚ+mbₚ₊₁, by iteratively solving the energy equations:
$${E}_{k , i + 1} ( {b}_{p} ) = {[ \frac{{λ}^{*} ( {b}_{p} )}{{{Q}^{H} ( {Q}_{e} {A}_{e , i}^{2} {Q}_{ei}^{H} + 2 {σ}^{2} {I}_{Nr ( N + L - 1 )} )}^{- 1} Q} ]}_{k , k}$$
$$for k = 1 , … , ( K - m ) and$$
$${E}_{k , i + 1} ( {b}_{p + 1} ) = {[ \frac{{λ}^{*} ( {b}_{p + 1} )}{{{Q}^{H} ( {Q}_{e} {A}_{e , i}^{2} {Q}_{e}^{H} + 2 {σ}^{2} {I}_{Nr ( N + L - 1 )} )}^{- 1} Q} ]}_{k , k}$$
for k=, . . . , (K−m) and for k=(K−m+1), . . . K respectively;
and then by iteratively formulating the energy vector \vec{E}ᵢ₊₁=[E_{1,i+1}, E_{2,i+1}, . . . , E_{K,i+1}] and setting i=i+1 and formulating the extended amplitude square matrix as A_{e,i}²=Diag([\vec{E}i \vec{E}i \vec{E}i]) and the repeating the energy calculation iterations until E_{k,i}=E_{k,(i-1)} or a given maximum number of iterations Iₘₐₓ is reached.

4. A method as claimed in claim 2, further comprising determining the energies to be allocated for a successive interference cancellation single-input single-output or multiple-input multiple-output receiver in order to maximize the total transmission rate R_{T}=(K*−m)bₚ+mbₚ₊₁, by solving the iterative energy equations
$${E}_{k , i} = \frac{Γ ( {2}^{{y}_{k}} - 1 )}{ξ - {E}_{k , ( i - 1 )} ( \frac{{\vert {ξ}_{3} \vert}^{2}}{1 + {E}_{k , ( i - 1 )} {ξ}_{1}} + \frac{{\vert {ξ}_{4} \vert}^{2}}{1 + {E}_{k , ( i - 1 )} {ξ}_{2}} )}$$
when using the main parameter the inverse covariance matrix Cₖ₋₁⁻¹, which changes from one channel to another during the energy calculation process, where for the first channel k=1 the available inverse covariance matrix is C₀⁻¹=(2σ²)⁻¹I_{N}_{ᵣ}_{(N+L-1)}, to calculate the distance vectors, \vec{d}, \vec{d}₁, \vec{d}₂ as \vec{d}=Cₖ₋₁⁻¹\vec{q}ₖ, \vec{d}₁=Cₖ₋₁⁻¹\vec{q}_{k,1} and \vec{d}₂=Cₖ₋₁⁻¹\vec{d}_{k,2} where \vec{q}_{k,1}=H_{Prev}\vec{s}ₖ and \vec{q}_{k,2}=H_{Next}\vec{s}ₖ and further to calculate the weighting factors ξ, ξ₁, ξ₂, ξ₃, ξ₄ as ξ=\vec{d}^{H}\vec{q}ₖ, ξ₁=\vec{d}₁^{H}\vec{q}_{k,1}, ξ₂=\vec{d}₂^{H}\vec{q}_{k,2}, ξ₃=\vec{d}^{H}\vec{q}_{k,1} and =ξ₄=\vec{d}^{H}\vec{q}_{k,2} when transmitting the data at the rate bₚ bits per symbol over the channel k for a target SNR of γ*ₖ=Γ(2^{b}^{ₚ}−1) and then by using the allocated energy Eₖ to calculate the inverse covariance matrix Cₖ⁻¹ using
$${C}_{k}^{- 1} = {C}_{k - 1}^{- 1} - ζ \vec{d} {\vec{d}}^{H} - ( {ζ}_{1} + {ζζ}_{1}^{2} {\vert {ξ}_{3} \vert}^{2} ) {\vec{d}}_{1} {\vec{d}}_{1}^{H} - ( {ζ}_{2} + {ζζ}_{2}^{2} {\vert {ξ}_{4} \vert}^{2} ) {\vec{d}}_{2} {\vec{d}}_{2}^{H} + {ζζ}_{1} ( {ζ}_{3} \vec{d} {\vec{d}}_{1}^{H} + {{ζ}_{3}^{*} ( \vec{d} {\vec{d}}_{1}^{H} )}^{H} ) + {ζζ}_{2} ( {ζ}_{4} \vec{d} {\vec{d}}_{2}^{H} + {{ζ}_{4}^{*} ( \vec{d} {\vec{d}}_{2}^{H} )}^{H} ) - {ζζ}_{1} {ζ}_{2} ( {ξ}_{3} {ξ}_{4}^{*} {\vec{d}}_{2} {\vec{d}}_{1}^{H} + {( {ξ}_{3} {ξ}_{4}^{*} )}^{*} {( {\vec{d}}_{2} {\vec{d}}_{1}^{H} )}^{H} ) .$$
by further defining matrix weighting factors ζ, ζ₁ and ζ₂ as
$$ζ = \frac{{E}_{k}}{1 + Γ ( {2}^{{b}_{p}} - 1 )} , {ζ}_{1} = \frac{{E}_{k}}{1 + {E}_{k} {ξ}_{1}} and {ζ}_{2} = \frac{{E}_{k}}{1 + {E}_{k} {ξ}_{2}}$$
and then by repeating the iterative energy calculations and the inverse covariance calculations if k<K* and then by updating k=k+1 until k=K*.

5. A method as claimed in claim 4, further comprising employing a successive interference calculation receiver for which the despreading filter coefficients are calculated by using the MMSE equalizer coefficients equation
$$\vec{wk} = \frac{{C}^{- 1} {\vec{q}}_{k}}{{\vec{q}}_{k}^{H} {C}^{- 1} {\vec{q}}_{k}}$$
for k=1, . . . , K* to produce the despreading filter coefficient vectors which are 2(N+L−1) dimensional column vectors which are used to formulate the 2(N+L−1)×K* dimensional despreading filter matrix
$$W = [ \begin{matrix}{W}_{1} \\ {W}_{2}\end{matrix} ] = [ {\vec{w}}_{1} , {\vec{w}}_{2} , … {\vec{w}}_{k} , {\vec{w}}_{{K}^{*}} , ]$$
and also the two (N+L−1)×K* dimensional despreading sequence matrices W₁=└\vec{w}_{1,1}, \vec{w}_{1,2}, . . . \vec{w}_{1,k}, \vec{w}_{1,K*}┘ and W₂=└\vec{w}_{2,1}, \vec{w}_{2,2}, . . . \vec{w}_{2,k}, \vec{w}_{2,K*}┘ which are used as the first set of despreading filter coefficients \vec{w}_{1,k} for k=K*, . . . , 1 at the output of first receiving antenna and as the second set of despreading filter coefficients \vec{w}_{2,k} for k=K*, . . . , 1 at the output of the second antenna to despread two sets of signals and then to add the despread signals to produce the demodulated signal at the output of each pair of received antennas and to produce versions of the signals appearing at the outputs of the chip matched filters of the receiving antennas when removing the interference coming from the detected signals in order to successively detect the transmitted data.

6-11. (canceled)
